(19) United States
(12) Patent Application Publication
(10) Pub. No.: US 2023/0074044 A1
(43) Pub. Date: Mar. 9, 2023

(54) G- MASK

(71) Applicant: MICHAEL C GRAYSON, Hollis, NY (US)

(72) Inventor: MICHAEL CURTIS GRAYSON, HOLLIS, NY (US)

(21) Appl. No.: 17/010,129

(22) Filed: Sep. 2, 2020

(51) Int. Cl. A62B 18/08; A62B 23/02; A62B 25/00

(52) U.S. Cl. CPC A62B 18/08; A62B 23/025; A62B 25/00

(57) ABSTRACT

A reusable multipurpose face mask is provided, particularly a face mask with a transparent shell, a housing having two air passageways with chambers that are covered by replaceable, disposable, and/or reusable membrane filters coupled to two openings in the transparent shell that are positioned on the sides of the face mask, and a third multipurpose opening that can be used for a housing having a mini rechargeable voice amplifier with built in microphone and speaker. An adjustable reusable hook and loop Velcro fastener elastic strap is attached to the transparent shell and adapted to be adjusted using the hook and loop and then removed and replaced by stretching the elastic strap while removing without having to adjust the Velcro strap each time. A system is also provided comprising the face mask and a germicidal UV light sterilization box for housing and recharging the mask when not in use.

### FIELD OF THE INVENTION

The present invention relates to a reusable multipurpose face mask, particularly a face mask with a transparent shell, a housing having two air passageways with chambers that are covered by replaceable, disposable, and/or reusable membrane filters coupled to two openings in the transparent shell that are positioned on the sides of the face mask, and a third multipurpose opening that can be used for a housing having a mini rechargeable voice amplifier with built in microphone and speaker.

### BACKGROUND

N95 respirators and surgical masks are examples of personal protective equipment that are used to protect the wearer from airborne particles and from liquid contaminating the face. The Centers for Disease Control and Prevention (CDC) National Institute for Occupational Safety and Health (NIOSH) and the Occupational Safety and Health Administration (OSHA) regulate N95 respirators thus making them almost impossible to acquire outside of certain professions. N95 Respirators are not for Use by the General Public however as the standard for safety there is incredible demand for this level of safety. Unfortunately, The Centers for Disease Control and Prevention (CDC) does not recommend that the general public wear N95 respirators to protect themselves from respiratory diseases, including coronavirus (COVID-19). Those are critical supplies that must continue to be reserved for health care workers and other medical first responders, as recommended by current CDC guidance. The face mask in this invention allows for N95 material to be used in its replacement filter membranes. Thereby giving the general public the safety of N95 without draining this critical supply.

CDC Recommends Cloth Face Coverings for Use by the General Public. The CDC recommends that members of the general public use simple cloth face coverings when in a public setting to slow the spread of viruses and disease, since this will help people who may have the virus and do not know it from transmitting it to others. Cloth Face Coverings are the least protective of all face mask and most infrequently and incorrectly used for several reasons. Cloth face coverings are designed to be reusable so as to avoid the high cost associated with constantly replacing surgical mask as directed. Unfortunately, cloth face coverings can trap the very disease and viruses that they are meant to protect the wearer from into the fabric of the cloth face covering. If not properly cleaned, sanitized and disinfected after each use this product becomes a health threat to the very user it was designed to protect. The face mask in this invention allows for the convenience and ease of use of the cloth face coverings without any of its negative side effects associated with the use of a cloth face covering. Thereby giving the general public the comfort of face coverings without compromising their safety.

A surgical mask is a loose-fitting, disposable device that creates a physical barrier between the mouth and nose of the wearer and potential contaminants in the immediate environment. Surgical masks are regulated under 21 CFR 878.4040. Surgical masks are not to be shared and may be labeled as surgical, isolation, dental, or medical procedure masks. They may come with or without a face shield. These are often referred to as face masks, although not all face masks are regulated as surgical masks. Surgical masks are made in different thicknesses and with different ability to protect you from contact with liquids. These properties may also affect how easily you can breathe through the face mask and how well the surgical mask protects you. If worn properly, a surgical mask is meant to help block large-particle droplets, splashes, sprays, or splatter that may contain germs (viruses and bacteria), keeping it from reaching your mouth and nose. Surgical masks may also help reduce exposure of your saliva and respiratory secretions to others. While a surgical mask may be effective in blocking splashes and large-particle droplets, a face mask, by design, does not filter or block very small particles in the air that may be transmitted by coughs, sneezes, or certain medical procedures. Surgical masks also do not provide complete protection from germs and other contaminants because of the loose fit between the surface of the mask and your face. In addition, Surgical masks are not intended to be used more than once. If your mask is damaged or soiled, or if breathing through the mask becomes difficult, it should be removed from the face mask, discard safely, and replace it with a new one. To safely discard your mask, place it in a plastic bag and put it in the trash. Wash your hands after handling the used mask. Surgical mask has several inherent problems that make it problematic for the general public to use, including but not limited to; poor prevention of virus and disease particle, cost associated with constant replacement, high probability of getting soiled, its ability to collect virus and disease material on its surface, the inability to dispose of properly, the uncomfortable fit, and many more. The face mask in this invention allows for the cost efficiency associated with the single use of the surgical mask and ease of use without any of its negative side effects associated with the use of surgical mask. Thereby giving the general public the positive benefits of a surgical mask without inherent risk of wearing a surgical mask.

Like an N95 respirator the G-mask described in this invention is a respiratory protective device designed to achieve a very close facial fit and very efficient filtration of airborne particles. Note that in both the edges are designed to form a seal around the nose and mouth.

The similarities among the G-mask invention herein described, surgical masks and surgical N95s are: They are effective for fluid resistance, filtration efficiency (particulate filtration efficiency and bacterial filtration efficiency), flammability and biocompatibility. The difference is the G-mask can be shared or reused.

G-mask is superior to other mask because it is good for people with chronic respiratory, cardiac, or other medical conditions that make breathing difficult. G-mask can be used when sterile conditions are needed. G-mask is not labeled as “single-use,” or disposable devices. If your G-mask is damaged it can be retrofitted. If your G-mask is soiled it can be cleaned. G-mask are designed for children or people with facial hair because it is adjustable and can provide full protection.

The FDA has issued Emergency Use Authorizations (EUAs) for the emergency use of decontamination systems for use in decontaminating certain respirators used by health care personnel when there are insufficient supplies of new respirators resulting from a pandemic. G-mask has its own LED UV decontamination sterilization storage box for when the device is not in use, to solve this problem.

G-mask eliminates the need for used respirators. The G-mask is intended to prevent specific diseases or infections, or otherwise represented as filtering surgical smoke or plumes, filtering specific amounts of viruses or bacteria, reducing the amount of and/or killing viruses, bacteria, or fungi, or affecting allergenicity, or contains coating technologies unrelated to filtration (e.g., to reduce and or kill microorganisms).

Face masks, such as those that are worn by construction workers, food preparers, individuals seeking to isolate themselves from germs and surgical face masks worn by health care professionals to protect patients and wearers. Such masks can catch debris, bacterial and viral particles shed from the wearer's mouth and nose. Additionally, the mask protects the wearer from inhaling t debris, bacterial and viral particles from individuals in close proximity or the surrounding environment. However, traditionally such masks are generally loose fitting, uncomfortable around the outer ear, unsanitary after the first use and inhibit the user from communicating with others. Accordingly, concerns have arisen as to the effectiveness of such face masks in protecting patients, individuals in close proximity and the wearer. In addition, with the rise of disease transmission rates there is a tremendous need for rethinking the face masks to greater meet the need of modern society. Disposable filter 10-20% of particles. However, with the help of a HEPA filter, 80-90% of particles can be blocked, making it nearly as efficient as an N95 mask.

The human face presents a challenge for prolong wearing of a face covering. The ears will become agitated upon prolonged contact with straps commonly used in face mask. Especially when you factor in the extra weight associated with supporting a mask that has been retrofitted with a device to accommodate speech and reusable multifunction membranes. Thus the modern mask must have a head strap that can be adjustable and preferably elastic.

Attempts have been made to make the mask reusable and disposable. However, cost becomes a relevant factor and thus making the entire mask disposable is cost prohibitive. Usually disposable masks that are cost effective, are of such inferior quality as to render them moot. Typically, face masks which include a disposable or reusable membrane offer the best compromise between cost and efficiency. In addition, in the current presentment allows for a high degree of customizable, utilization and a multifunction approach.

Some face masks have incorporated a reusable or disposable membrane filter, however the invention in this current presentment offers the flexibility and customization not yet seen in this type of device. This invention allows for a replacement filter membrane that can block dust particles and then be replaced by a bio filter that blocks bacteria. The device in this presentment can even incorporate custom membrane filters that can block specific viruses or particulate matter. Even chemical and smoke filters can be use by this invention. This device can even address the need to block foul odors.

Generally, the overall effectiveness of traditional face mask is diminished by multiple uses. Each use further contaminates the mask. In the current embodiments disclosed herein relates to a wearable device that is housed in a portable UV light sanitizer case that also recharges the device.

In some embodiments a face mask can include a generally cup shaped mask body that includes an opening and a recess, the recess can be shaped to receive oral and nasal features of a human face, this design makes talking difficult and hearing the wearer clearly almost impossible. That is why the current invention includes a voice amplifier that eliminates the need to remove the mask to speak on the phone or in person. The mini rechargeable amplifier device is attached directly to the face mask and picks up the natural speech of the wearer and transmits it through a built in speaker.

### SUMMARY

In some embodiments, the moldable member is a material that molds to fit the contours of the face of the user. Preferably, the moldable member substantially retains its shape even when removed from the face of the wearer such that the mask has a customized fit specific for the wearer. “Substantially” retaining it shape can mean that the moldable member maintains 50%-99% of its molded shape to fit the wearer's facial contour. The moldable member can include or be made of any other suitable material such that it can be mold to the face of the wearer and substantially retain its shape.

In some embodiments, the peripheral edge further can include, for example, a pressure-sensitive adhesive.

In some embodiments, the mask body can include, for example, at least one electronic voice enhancement device therein where said device is located thereon.

In some embodiments, the mask body can include, for example, at least one exhalation valve opening disposed therein where said exhalation valve is located thereon. In some embodiments, the mask body can include, for example, at least one inhalation valve opening disposed therein where said inhalation valve is located thereon. In some embodiments, the mask body can include, for example, at least one exhalation valve and at least one inhalation valve. In some embodiments, the least one of said at least two valves can be replaceable. In some embodiments the inhalation and exhalation valves can be part of a single valve unit that functions as both an inhalation and exhalation valve.

In some embodiments, the filter membrane element can be replaceable. In some embodiments, the filter element can include, for example, a fibrous material, an open-cell foam, or the like.

In some embodiments, the least one of said at least two valves can be placed on the side of the mask so as not to obstruct the view of the mouth in this clear plastic device.

In some embodiments, the replaceable filter element of at least one of said least two valves can include a filter that can qualify as an N95 filter, for example. In some embodiments, the filter element of at least one of said least two valves can include a filter that can qualify as a N99 filter, for example. In some embodiments, the filter element of at least one of said least two valves can include a filter that can qualify as any other NIOSH rating, for example, P100 and OV-100, for example. In some embodiments a single filter element can include, for example, two or more filter pieces with different NIOSH ratings (e.g., N95, N99, P100, OV-100, etc.).

In some embodiments, the least one of said at least two valves can include a valve member, wherein said filter element extends over an exterior of said valve member. In some embodiments, the least one of said at least two valves can include a valve member, wherein said filter element extends over an interior of said valve member. In some embodiments, the least one of said at least two valves can be coupled to said mask body by a device such as, for example, a flange snap fit means, a direct pressure snap fit.

In some embodiments, the at least one retention member can include, for example, an elastomeric member coupled to said mask body. The retention member further can include, for example, and a hook and loop strap coupled to said elastomeric member.

In some embodiments, a face mask described herein can further include at least one viso-elastic member disposed on the interior of said mask body at a location that can be aligned with a position such as the nasal bridge of a user, and the lower chin of a user, for example.

In some embodiments, a face mask described herein can include, for example, a styrene-based polymer, an isopyrene polymer, a low density polyethylene copolymer, and/or mixtures thereof, and the like.

In some embodiments, a face mask described herein can further include a generally cup shaped clear bio resistant plastic insert that includes an opening and a recess, the recess shaped to receive oral and nasal features of a human face, and said insert can be adapted to be inserted into said mask body. In some embodiments, the insert further can include, for example, at least one exhalation valve opening disposed therein where said exhalation valve is located thereon, and at least one inhalation valve opening disposed therein where said inhalation valve is located thereon. In some aspects, at least one single valve that has the ability to filter both inhaled and exhaled gas may be used. In some embodiments, the insert can be replaceable. The insert can be comprised of a material that provides filtration, for example, an N95 or higher filter material (e.g., N99, P100, OV-100, etc.). The insert can include a cloth material, a moisture absorbing material, and the like.

Some face masks described herein can include a generally cup shaped mask body that includes, for example, an opening and a recess, the recess shaped to receive oral and nasal features of a human face, the opening having a peripheral edge shaped to generally follow a contour of a human face extending around the nasal and oral areas; a moldable member coupled to said peripheral edge, wherein said moldable member extends for at least a portion of said peripheral edge; and at least one retention member attached to said mask body. In some aspects the moldable member can extend continuously over the entire length of the peripheral edge. In some aspects the member can extend discontinuously over the length of the peripheral edge. In some aspects, the moldable member can extend over 40%-100% of the peripheral edge of the mask body. In some aspects, the mask can include more than one moldable member (e.g., a separate layer inside of or adjacent to the outer layer). The masks further can include any of the other devices and features described herein. The masks can specifically exclude one or more of the other features or apparatus described above and elsewhere herein.

Some embodiments described herein can include methods for removing contaminants from an inhale flow stream and exhale flow stream of a user. Such methods can include obtaining a face mask described above and elsewhere herein and contacting it with the face of user thereby removing contaminants that are exhaled from the user and filtering contaminates in air inhaled by the user. Further methods can include obtaining a face mask described herein; molding a moldable member as described herein, to a contour extending around the nasal and oral areas of said user's face; and placing the mask over at least the user's oral and nasal features, such that a substantial portion of the inhaled air (e.g., 50%-100%, preferably 80%-100%, for example) passes through at least one inhalation valve, and a substantial portion of the exhaled air (e.g., 50%-100%, preferably 80%-100%, for example) passes through at least one exhalation valve. In some aspects, the inhalation and exhalation valves can include at least one valve where they are the same. In some embodiments, the molding can include a plastic member; and contacting the face of said user with said plastic member such that said plastic member contours a region extending around the nasal and oral areas of said user's face. In some embodiments, the peripheral edge further can include, for example, a pressure-sensitive adhesive, such that said pressure-sensitive adhesive contacts a contour extending around the nasal and oral areas of said user's face.

Some embodiments described herein include face mask kits, for example, for assembling or replacing parts of a face mask. The kits can include, for example, one or more of the following: a generally cup shaped mask body that includes an opening and a recess, the recess shaped to receive oral and nasal features of a human face, the opening having a peripheral edge shaped to generally follow a contour of a human face extending around the nasal and oral areas; a moldable member as described herein coupled to said peripheral edge, wherein said moldable member extends for at least a portion of said peripheral edge; at least two valves comprising at least one exhalation valve and at least one inhalation valve, wherein said at least two valves each comprise a filter element; at least generally cup shaped insert comprising an opening and a recess, the recess shaped to receive oral and nasal features of a human face, and said insert is adapted to be inserted into said mask body; at least one retention member; and optionally, instructions for assembling the face mask. In some aspects the device can include a single apparatus that functions as both an exhalation and inhalation valve. In some embodiments, a kit further can include a pressure-sensitive adhesive or other suitable adhesive. It should also be understood that the mask body and/or elements of the mask such as the electronic voice enhancer amplifier is connected to a separate opening in the mask. This opening can accommodate numerous attachments.

Some embodiments relate to reusable surgical face masks of a generally cup shaped design. It should also be understood that the mask body and/or elements of the mask such as filter elements or voice amplifier are connected directly to the mask through an opening. The masks can be constructed of soft plastic copolymer. The masks can include, for example, a mask body that includes one or more receptacles; at least one reusable, replaceable or both reusable and replaceable filtered exhalation valve, wherein the at least one exhalation valve is configured to fit into a receptacle in the mask body; at least one reusable, replaceable or both reusable and replaceable filtered inhalation valve wherein the at least one inhalation valve is configured to fit into a receptacle in the mask body; at least one voice amplifier device is configured to fit into a receptacle in the mask body; a moldable border around the entire perimeter of the mask that can molded to the face of a user; and a retention or strap system for securing the mask to the face of the user. For example, the retention system can include a passive/active adjustable strap system for securing the mask to the user's head.

For example, the border can be made of a more flexible plastic than the body of the mask or a gel, such that it can conform to the face of a user.

In some aspects, the border may be secured to the perimeter section of the mask body by the use of elongated oval spaced fenestrations around said perimeter of the mask body. The border may be secured to the perimeter section of the mask body, for example, by using a soft malleable metal strip, or strips, which is/are incorporated into the mask body perimeter. The border may be secured to the mask body by using a strip or strips of a plastic elastomeric compound which is molded into the mask perimeter section.

The mask can include, for example, one or more, preferably at least two exhalation valves. The exhalation valves may be for example multi-use detachable replaceable exhalation valves that are secured to the outer sides of the mask. In some aspects, at least one such valve may be secured to the central portion of the mask by utilizing one or more of a flange snap fit; or a direct pressure snap fit. In some aspects a single voice amplification valve can be used.

The mask body can include, for example, a unique passive active adjustable strap system for attaching the mask to the user's head. The system may include, for example, an elastomeric coupler attached to the mask housing by small bridges molded into the mask housing; and hook and loop straps which attach to the elastomeric sections and secure to their respective opposite ends.

The mask body may include, for example, a styrene-based thermoplastic elastomeric compound. In some aspects, the mask body may include, for example, an isopyrene polymer. The mask body may include, for example, any combination of LDPE, styrene-based polymers, isopyrene based polymers and/or other polymers and/or copolymers of thermoplastic elastomeric composition, and the like.

Some embodiments relate to an inhalation/exhalation valve assembly, which assembly can include, for example, one or more of a valve housing with two chambers, one enclosing a thin valve supported by a valve post and retaining disc molded into the valve housing; a filter element of NIOSH N95 qualification (or other qualification, e.g., N99, P100, OV-100, etc.); a filter element of NIOSH N99 qualification (or other qualification, e.g., N95, P100, OV-100, etc.); and an open cross bridged housing on both sides for air flow through the valve and filter. Such valves assemblies can be utilized with any of the masks described herein, if desired. The valve assembly further may include, for example, an outer perimeter molded flange for a twisting snap fit securing action. The valve assembly may include a threaded perimeter for a twisting screw-in securing action to secure the valve into a mask valve receiving region.

Some embodiments relate to valve assemblies as described herein that are configured to directly snap fit into a mask housing. The valve can be reusable and/or disposable. There is also a valve assembly that may include a voice amplifier.

Some embodiments relate to masks that utilize at least one valve assembly as described herein. The at least one valve assembly may be molded into the mask body as a permanent part of the mask body. The outer housing cover over the valves may include, for example, one or more of: a molded cover with space beneath by which air flow is allowed across the valve assembly; a molded disc with cross sections to allow air flow across the valve assembly; cross sections directly molded into the mask housing flush to the secured valves; and the like. The masks further may include a replaceable adhesive backed strip of material attachable on the inside of the mask body. Said material can include, for example: (a) synthetic elastomeric foam; (b) synthetic felt; (c) any such material designed for similar purposes; or (d) combinations of any of (a)-(d). The material may be attached, for example, at either the inside of the mask body at the nasal bridge and/or along the inside of the mask body at the lower chin section.

Some embodiments relate to masks that include a body, wherein the body comprises a rechargeable voice amplifier section. The device amplifies your voice and makes it possible to communicate with others or a cell phone while wearing a mask. The sound is clear, crisp, no noise and no distortion. You can use USB cable to charge this mini voice amplifier. There may be an on off switch and the volume may be adjustable. Made of durable and wear-resistant ABS material, this voice amplifier is compact and durable.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 shows placement of the mask.

FIG. 2 shows a frontal view of the mask.

FIG. 3 shows the placement of the retention member of a face mask.

FIG. 4 shows an inside view angle of a face mask with a close-up view of the mask perimeter section, perimeter edge, and moldable border.

FIG. 5 shows a side view of a face mask.

FIG. 6 shows a view of the face mask storage box.

FIG. 7 shows the mini voice amplifier with speaker.

FIG. 8 shows the side view of the mask wearer.

FIG. 9 shows the adjustable Velcro strap.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Generally, embodiments relate to face masks, for example that can be used in a surgical, isolation, dental or construction field, but not limited to such use. The masks can include a custom fitting reusable (if desired) mask body, one or more multiuse filtered valves (replaceable if desired), a mini voice amplifier with speaker (if desired), a LED UV light sterilization storage box and an adjustable detachable strap system, for example.

The mask body can be composed of, for example, a cup-shaped shell. Preferably, the cup-shaped shell can be made of a semi-rigid clear plastic. Any suitable material can be used. For example, the body can be made of a plastic copolymer. In some aspects the shell can be made of a material that can be cleaned and/or sterilized. Also the mask must be made of a material that reacts well to LED UV sterilization. The mask border perimeter can include a moldable, pliable or form fitting material (e.g., a moldable member) that permits at least a portion of the mask (e.g., the perimeter border or any other part that is desired to be custom fitted) to be custom fitted to the individual's face. In some aspects the moldable material can include a material that can be molded to the contours of the user's face and that will substantially retain its shape. In some aspects, the term “substantially retain” can mean that it will maintain about 50%-100% of its molded shape at least 1 day to about 1 month, for example. The semi rigid mask body can include at least one filtered inhalation valve, for example, located on the sides of the mask and one or more filtered exhalation valves, for example. These valves can be of a multiuse detachable replaceable/reusable design. In some aspects a single device can be used that can function to filter both inhalation and exhalation air. Preferably, the valve or valves have an airflow capacity that permits all of the exhaled and inhaled air to pass through the valves rather than through the perimeter of the mask, when the mask is secured to the head of a user. The semi rigid mask body can include at least one mini voice amplifier with speaker. The amplifier will allow for uninterrupted and free flowing speech from the wearer. The semi rigid mask body can include at least one LED UV sterilization storage box. After daily use the wearer will insert the mask into this device for storage, transportation and sterilization. In some aspects, one or more of the components described above and elsewhere herein can be specifically excluded from some embodiments.

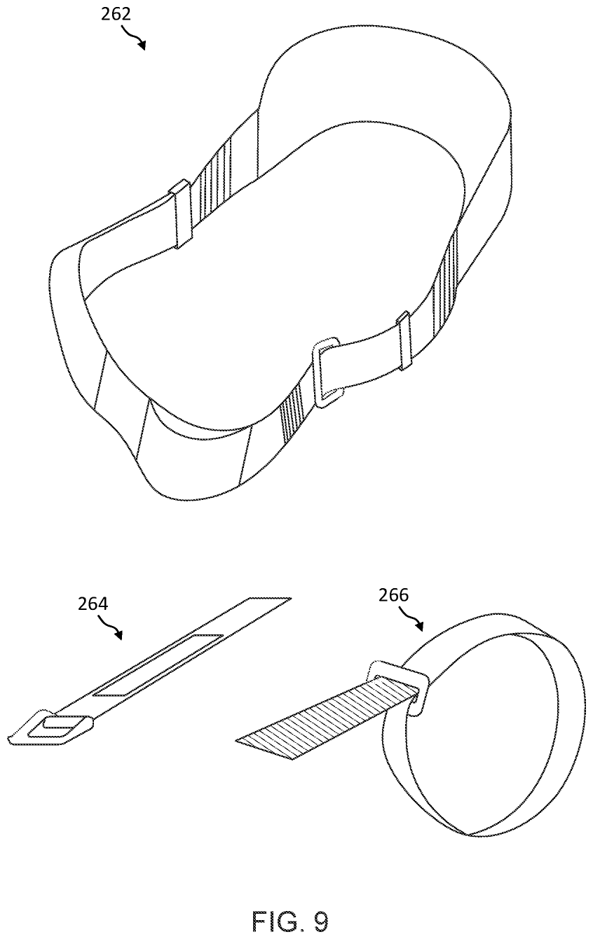

The mask body can be held to the wearer by an attachment mechanism FIG. 9. Any suitable mechanism can be utilized. The mechanism can include a hook and loop Velcro elastic material and non-elastic material. The attachment mechanism can include clips, buttons, clamps, hook and loop (e.g., Velcro®), the like, etc. Preferably, the attachment mechanism can be a one piece (or more) partially elastic passive/active adjustable/detachable strap system. In some aspects the masks can include a colored strap. For example, the straps can come in a variety of colors, and can be used as a means of applying unique identifiers for the different categories of operating room personnel, for example. The colors can also be used as size, source, or ownership identifiers, for example. The colors can be used to personalize the masks, which can be reused. The various functions of the different colored straps can be particularly useful or important in certain settings, such as surgical settings.

The masks, mask components, other mask features, and methods described herein described herein, can provide greater protection to both the user and those around the user. In the isolation, dental, construction or surgical setting, the described technology can provide protection for the wearer of the mask, as well as, those in close proximity to the wearer. Furthermore, in some aspects many of the components of the masks can be reused, while others can be replaced, resulting in masks that provide greater comfort, safety, speech enhancement, sterilization and significant cost savings, compared to masks of the prior art.

Some embodiments generally relate to wearable articles including face masks, in particular, including moldable face masks. Some moldable face masks can include, for example, at least one inhalation valve. Some moldable face masks can include, for example, at least one exhalation valve. Some moldable face masks can include, for example, both at least one inhalation valve and at least on exhalation valve. In some aspects a single valve can be used that function to filter both inhalation and exhalation gases. Some embodiments relate to components of the masks and mask systems described herein. Further aspects include methods for reducing contaminants in an inhalation and exhalation flow stream, and methods and kits for assembling the face masks and components thereof described herein.

The face masks and mask components described herein can be used in applications where it is desirable to reduce contaminants flowing to and from a wearer's nose and mouth during exhalation and inhalation. Such contaminants can include, for example, bacteria, viruses, surgical smoke, odors, dust and the like. As used herein, “wearer” and “user” can be synonymous. Generally, the face masks described herein may be used by health care professionals or any other user who desires to avoid contamination or who desires to avoid spreading a contaminant.

Some face masks described herein can include a generally cup shaped mask body comprising an opening and a recess, the recess shaped to receive oral and nasal features of a human face, the opening having a peripheral edge shaped to generally follow a contour of a human face extending around the nasal and oral areas; a moldable member or sealing member coupled to said peripheral edge, wherein said member extends for at least a portion of said peripheral edge; one or more valves, for example, an exhalation valve that is disposed on the mask body and has at least one orifice that allows exhaled air to pass from an interior gas space to an exterior gas space during an exhalation; or at least one inhalation valve that is disposed on the mask body and has at least one orifice that allows inhaled air to pass from an exterior gas space to an interior gas space during an inhalation, wherein said valves include a filter element; and at least one retention member attached to said mask body. In some aspects, the inhalation and exhalation valves can be the same or part of a single valve system. More than one of the valves can be utilized if desired. The valves can be replaceable in some aspects. It should also be understood that the mask body and/or elements of the mask such as filter elements or filter cavities can at least partially have a trapezoidal shape. For example, without being limited thereto, the cup shaped mask may have a trapezoidal opening or a trapezoidal shape at the distal end.

In some embodiments, the mask has a mini voice amplifier with speaker. This Voice Amplifier amplifies your voice and allows you to communicate with others in your surroundings or your cell phone. Without this device most people have a difficult time speaking loudly enough through the mask. This device delivers a clear and soft sound to cover the range of the normal speaking voice or greater. Not only an amplifier but also a portable speaker. This light weight power box system is a portable public address system. The amplifier system is rechargeable with a built-in lithium battery.

Preferably, the mask can include at least two valves, including at least one exhalation valve that is disposed on the mask body and has at least one orifice that allows exhaled air to pass from an interior gas space to an exterior gas space during an exhalation; and at least one inhalation valve that is disposed on the mask body and has at least one orifice that allows inhaled air to pass from an exterior gas space to an interior gas space during an inhalation, wherein said at least two valves each comprise a filter element.

The face masks described herein can be molded to the contours surrounding the nose and mouth of a particular user's face. In some embodiments, a moldable member as described herein can be used. Face mask can be made pliable and molded to the contours of a user's face. Because contours of human faces can vary enormously, this feature can be particularly advantageous to produce a tight fit at the edges of the face mask and reduce the amount of air flowing around the periphery of the face mask.

A LED UV sterilization storage box can be used with the mask. This ALL-PURPOSE STERILIZER BOX can be used for face mask aids and personal items. It can use an ADVANCED UV-C LIGHT—Offering wide wavelength coverage at 260-280 mm, this UV sterilization box with reflective glass provides 360° of protection for universal support. The storage box has a SIMPLE, PORTABLE DESIGN—Small enough to carry, use in the car, or place in your purse. The sterilizing boxes are easy to use, work quickly, and shut off automatically. They PROMOTE HEALTHIER LIFESTYLES—Using the UV POD UV-C light storage box to help sterilize the mask and accessories can help reduce the spread of germs, bacteria and impurities. The sterilization box helps alleviates the problem with reusable mask not being sufficiently sterile.

In some embodiments, a face mask further may include a pressure sensitive adhesive on the peripheral edge of the mask such that a seal can be made between the periphery of the face mask and the user's face, for example. Generally, any pressure sensitive adhesive may be used. Preferably, the pressure sensitive adhesive does not cause irritation to human skin or is so aggressively adhesive that it causes pain to the user when removed from the skin. It also can be desirable that the adhesive is selected such that the adhesive does not leave a substantial amount of an adhesive residue on the surface of the skin of the user, when mask is removed by the user after use.

In addition, some of the face masks described herein can include at least one inhalation valve and at least one exhalation valve. Such valves can include filter elements that remove contaminants from the inhalation and exhalation air flow of a user. It is envisioned that the proportion of the inhalation air flow and/or exhalation air flow that will pass through the filter elements of the inhalation and exhalation valves will be at least 30%, 40%, 50%, 60%, 70%, 80%, 90%, 95%, 99%, and 100% or any value in between. In some embodiments, the inhalation valves and exhalation valves can be reusable. In some aspects the valves can be replaceable. In some embodiments, filter elements of the inhalation valves and exhalation valves are reusable and/or replaceable. In some aspects one or more single valves can be used that are capable of filtering both inhaled and exhaled gases. Some valve filters can be used to eliminate odors, or to block dust particles. The customization of the valve filters allows the mask to be used for multiple functions. Most other mask has only single use functionality.

In some embodiments, the face masks described herein can include a passive-active adjustable strap system to hold the mask in place over a user's nose and mouth. This strap can include retention members. The retention members can include, for example, a one-piece adjustable head strap that allows the user to set the tension specific to their facial cranial anatomy, while allowing for a degree of elasticity in the headbands.

Face masks can further include a disposable generally cup shaped insert. The insert can include an opening and a recess, the recess shaped to receive oral and nasal features of a human face, where the insert is adapted to be inserted into the body of the mask, for example, within the perimeter of the shell and the moldable material. In some embodiments, the inserts further can include one or more holes or openings to permit gas or airflow through the inhalation and exhalation valves. For example, the holes or openings can be positioned to line up with the inhalation and/or exhalation valve(s). The inserts can include attachment mechanisms to secure the inserts to the interior of the mask body or to secure the inserts in an appropriate position relative to the valves. For example, the inserts can include openings with O-rings that can fit onto or around the one or more valves.

The inserts can be of any suitable material. For example, the inserts can include a filter material, such as a fibrous material, or an open-cell foam. In some aspects, the inserts can include an N95 or higher material (e.g., N99, P100, OV-100, etc.). The inserts can include a material that is moisture absorbing, which provides comfort, etc. It should also be understood that the mask body and/or elements of the mask such as filter elements or filter cavities are located on the sides of the mask to not obstruct the view of the mouth.

In addition to the face masks described herein, methods for reducing or removing contaminants from an inhale flow stream and exhale flow stream of a user are described. As used herein “removing” can refer to removing, blocking or filtering at least a portion, for example at least a portion of the contaminants in airflow. At least a portion can mean, in some aspects, removing 50%-100% of contaminants (or any value there between), preferably 90%-100% of the contaminants. Some such methods can include, for example, obtaining a face mask described herein and placing the mask over at least the user's oral and nasal features. Also, some such methods can include, for example, obtaining a face mask described herein; molding a moldable member to a contour extending around the nasal and oral areas of said user's face; and placing the mask over at least the user's oral and nasal features, such that a substantial portion (e.g., 50-100% or any amount there between) of the inhaled air passes through said at least one inhalation valve, and a substantial portion (e.g., 50-100% or any amount there between) of the exhaled air passes through said at least one exhalation valve.

Also described herein are kits for assembling or replacing components of a face mask. Such kits can include, for example, one or more of: a generally cup shaped mask body that includes an opening and a recess, the recess shaped to receive oral and nasal features of a human face, the opening having a peripheral edge shaped to generally follow a contour of a human face extending around the nasal and oral areas; malleable or moldable member coupled to said peripheral edge, wherein said member extends for at least a portion of said peripheral edge (e.g., 40%-100% or any value in between); one or more valves such as an exhalation valve or an inhalation valve; at least generally cup shaped insert that includes an opening and a recess, the recess shaped to receive oral and nasal features of a human face, and wherein insert is adapted to be inserted into said mask body; at least one retention member; and instructions for assembling the face mask.

Some kits can include a mini voice amplifier with speaker member coupled to said peripheral edge, wherein said amplifier is located near the base of the mask and extends for at least a portion of said peripheral edge. Some kits can include a LED UV light box sterilization storage unit for the mask. In some aspects the major benefit to the box is its portability and flexibility. The kits can include both a moldable member and a pressure-sensitive member. In some aspects, the kits can include at least two valves comprising at least one exhalation valve and at least one inhalation valve, wherein said at least two valves each include a filter element. In some aspects, the inhalation and exhalation valve(s) can be the same. It should also be understood that the mask body and/or elements of the mask such as filter elements or filter cavities can be located as not to obstruct the view of the mouth through the clear plastic device.

Some embodiments relate to methods of making or custom fitting a mask to a user. The methods can include any of the materials and or methods described herein. The methods can specifically exclude one or more of the materials, components and/or methods described herein. For example, the methods can include providing a mask shell (e.g., as described herein), which shell includes a moldable member, along with instructions for molding the mask to conform substantially, at least around a portion of the mask perimeter, to the face of a user. The mask shell further can include one or more holes or openings that can receive one or more valves for inhalation and/or exhalation. The shell can include a suitable attachment mechanism including the mechanisms described herein. The attachment mechanism can include colored components, for example, to designate the type of personnel, the size, and/or the type of use that may be appropriate for the mask. By appropriate use, for example, one color may designate use in a particular clean room. Some straps may be of a color that designates suitability for use in a clean room (e g, manufacturing environment), an operating room, etc. The methods may include the use of any other components as described herein.

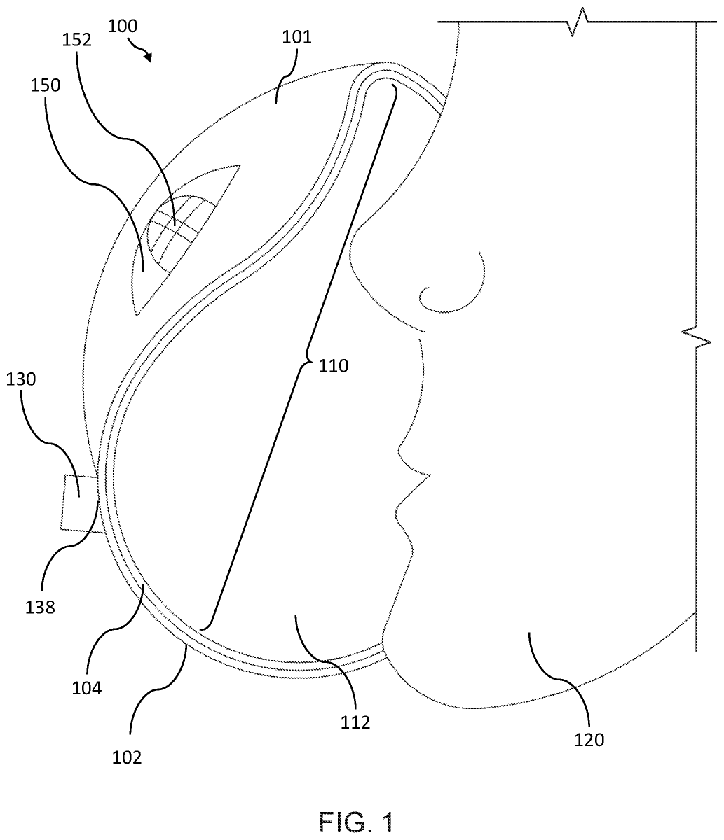

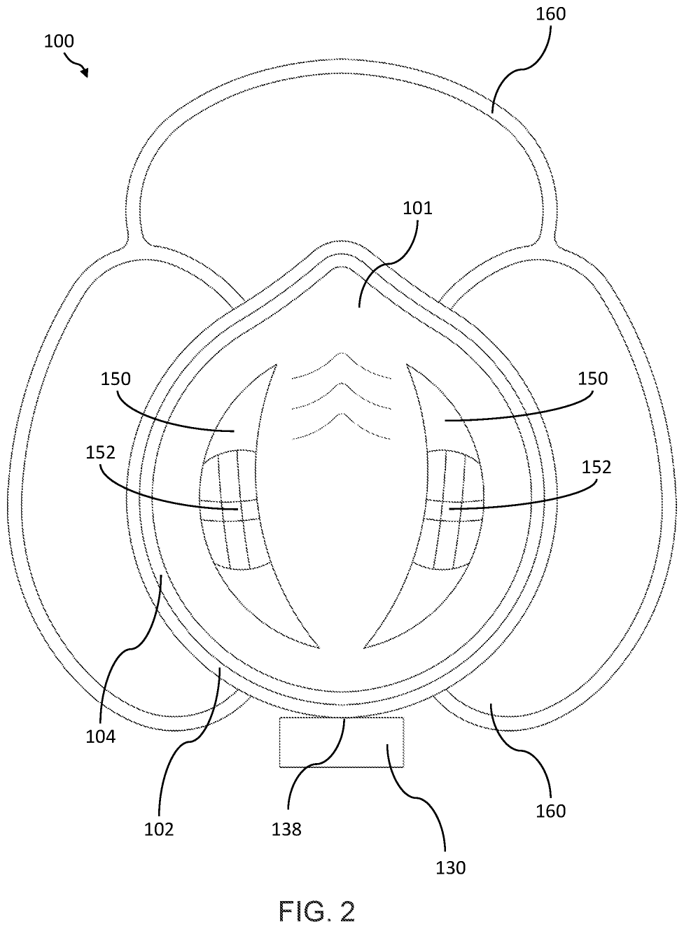

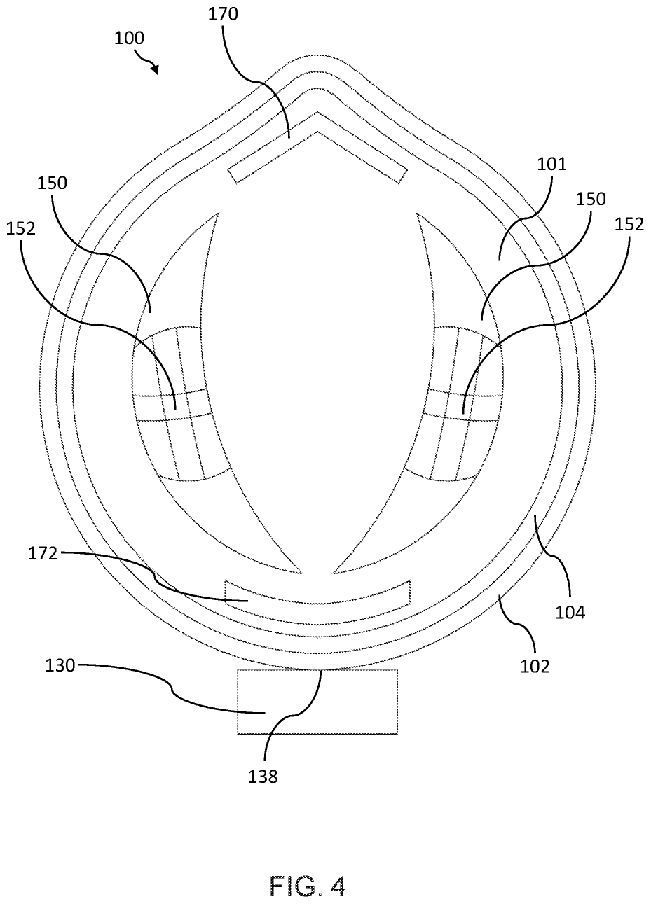

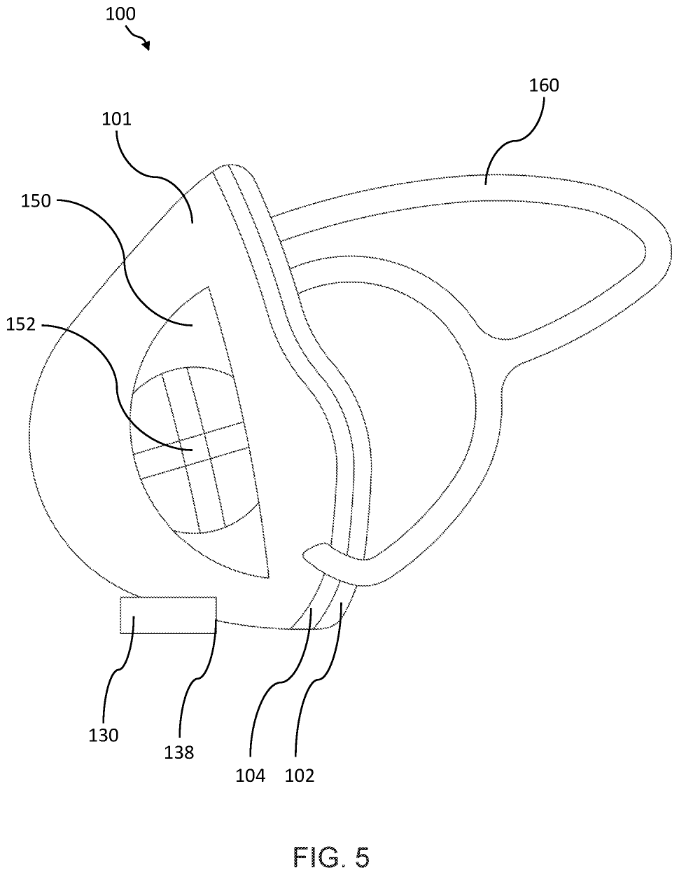

Referring to FIGS. 1 and 2, in some embodiments a face mask 100 can include, for example, a generally cup shaped mask body 101 with an opening 110 and a recess 112, the recess shaped to receive oral and nasal features of a human face 120, such as the bridge of the nose, cheeks, mid to lower mandible of the jaw, and under the chin. The mask body 101 can have a peripheral edge 102 (see FIG. 4) shaped to generally follow a contour of a human face 120 extending around the nasal and oral areas. The peripheral edge 102 can be adjacent to a peripheral section 104 (see FIG. 5) of the mask body 100.

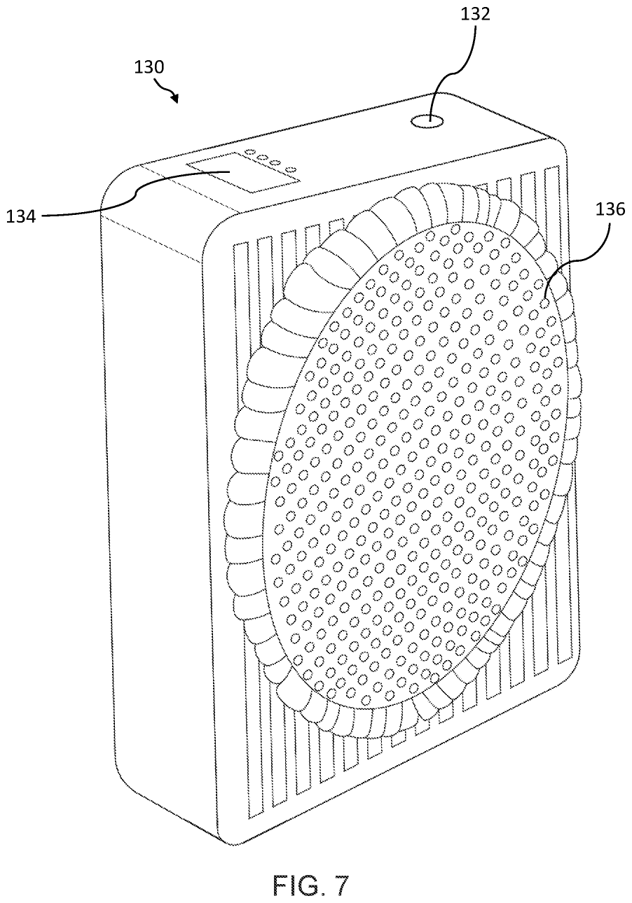

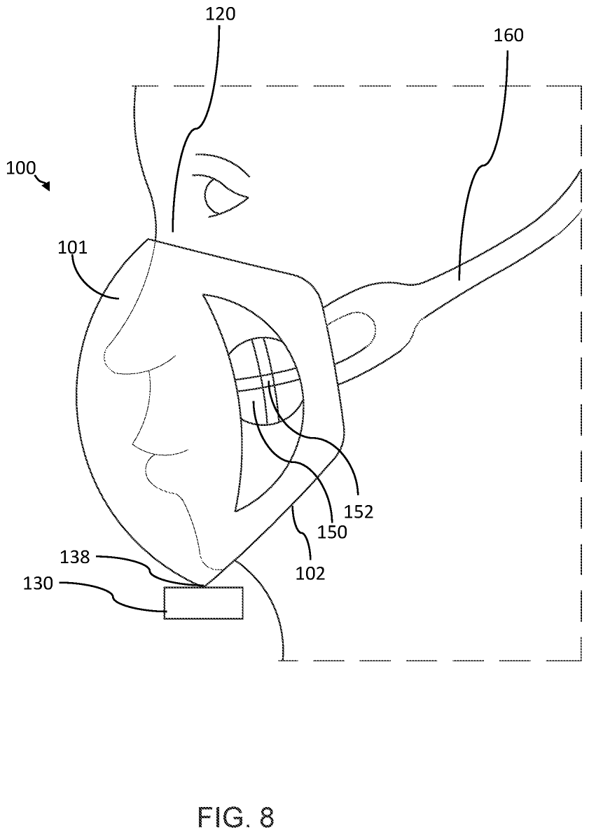

In some embodiments, the mask body 101 can include a mini voice amplifier and speaker member 130 (see FIG. 7) as described herein. The amplifier member 130 may be referred to herein as a mini voice amplifier recharger speaker member. However, it should be understood that other types of amplifier members are contemplated for use, but are not necessarily specifically mentioned in connection with the drawings. Thus, whenever an amplifier member is mentioned, it should be appreciated that other types of amplifier members can be substituted or used in addition to the current speaker member. In some embodiments, the amplifier member 130 can be coupled to the lower peripheral edge 102 (see FIG. 8) of the mask body 101. The amplifier 130 can facilitate normal speech without necessitating the removal of the mask during face to face or cell phone communications. As used herein, the device can magnify or simply clarify human speech so that it can be easily heard and understood In some embodiments, the mask is constructed such that it does not tough the mouth of the wearer and their fore the speech can be clearly picked up by the mic of the amplifier.

The amplifier member 130 (see FIG. 7) can include a microphone (not shown). The amplifier member can contain a wireless microphone (not shown). This WIRELESS MICROPHONE SYSTEM has a Built-in high sensitivity professional Dynamic microphone. It has Signal stability, No delay, No radiation, Anti-howling, Anti-jamming, Constant frequency, anti-Distortion and noise cancelation technologies. The mic is built into the amplifier member and fits flush in the mask. It is made of and alloy material which is harder, lighter and more wear-resistant than traditional microphone. This EASY TO USE MICROPHONE is built in and seamless. The microphone gets its power from the rechargeable member system. It is a PROFESSIONAL DUAL CHANNEL DYNAMIC MICROPHONE with a Built-in moving-coil microphone, widely applied to conference, general speech, outdoor and indoor applications.

In some embodiments, generally, the mask body 101 can include a non-porous material. The peripheral edge 102 may comprise a plastic member (not shown) that can allow for the mask 100 to custom fit the specific facial contours of the user (see FIG. 4). FIGS. 2 and 4 depict a mask body 101 with a moldable border attached to the peripheral edge 102 via an overlapping of the border around the peripheral edge along the mask body perimeter section. Such a configuration can help to “anchor” the moldable member.

The face mask 100 as depicted in FIG. 1 includes valves 150 and amplifier 130. FIG. 2 shows these elements along with head strap 160. The valves 150 can include at least one inhalation valve that is disposed on the mask body and has at least one orifice that allows inhaled air to pass from an exterior gas space to an interior gas space during an inhalation, and at least one exhalation valve that is disposed on the mask body and has at least one orifice that allows exhaled air to pass from an interior gas space to an exterior gas space during an exhalation. Without being limited thereto, the valves 150, including the inhalation valve(s) can be disposed within a SIDE location of the mask body 101. Such a SIDE location may be the optimal path to showcase the mouth. Without being limited thereto, the valves 150, including the exhalation valve(s) can be disposed at the outer sides of the mask body 101. The depicted valves 150 include a filter 152 within the valve apparatus. The filter 152 can be of a type, for example, that meets the National Institute of Occupational Safety and Health (NIOSH) standards, including the N 95 standards (95% filtering efficiency of all non-oil based particles as defined by the NIOSH). It should also be noted that in some embodiments one or more valves that filter both inhalation and exhalation gas may be utilized.

The head strap 260 of face mask 200 may include a passive-active adjustable strap system 262 attached to the mask body 201 (see FIG. 9). It should be noted that other types of retention or strap systems may be used to secure the face mask 200 to the face of the user. The depicted system in FIG. 9 can include an elastomeric coupler 264 that attaches to the mask body 201 at raised bridges in the mask body. A hook-and-loop fastener strip 266, for example, made of nylon or polyester, can be coupled to the elastomeric coupler 264. Although not depicted, the straps can be at least partially color coded as discussed elsewhere herein.

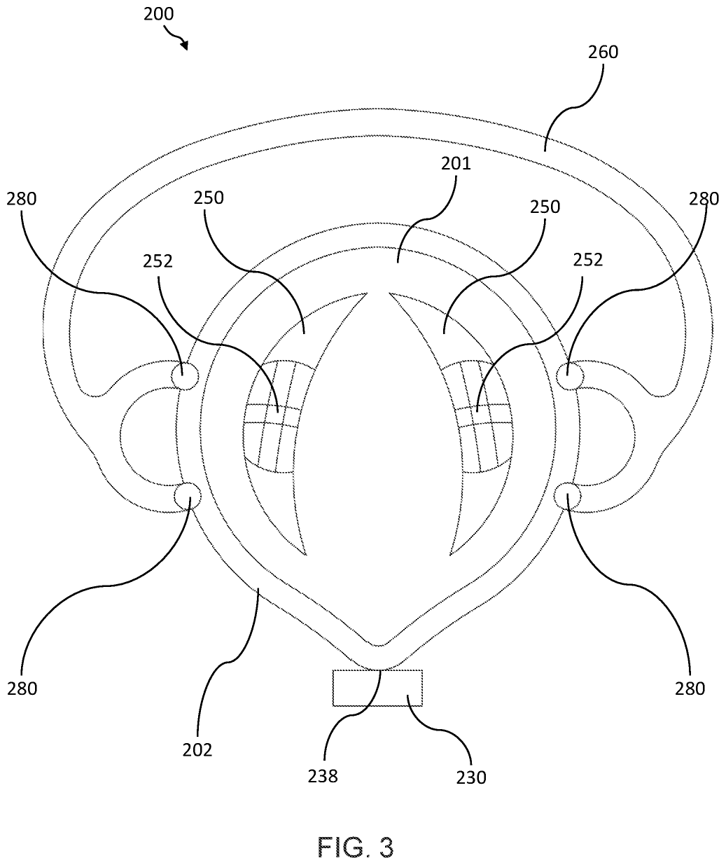

Some face masks described herein can include a retention system or member for attachment of the mask to the face of the user. FIG. 3 illustrates an example of a system for attachment of the mask body 201 to the face of a user, wherein the system for attachment comprises head strap 260. In FIG. 3 the head strap 260 comprises an elastomeric material and attaches to, and can detach from, peripheral edge 202 of mask body 201 by a looping action at four bridges 280 that are part of the peripheral edge 202 of mask body 201. A hook and loop strap 266 (see FIG. 9) can be coupled to the head strap 260 by a variety of methods. In one embodiment, the hook and loop strap 266 can come in a variety of colors, and can be used as a means of applying unique identifiers for the different categories of operating room personnel. In FIG. 3, the head strap 260 comprising elastomeric material is attached to the peripheral edge 202 of mask body 201 and wraps around the back of the head with a single strap. This methodology allows for an easier and more comfortable fit.

Referring to FIG. 4, face mask 100 is shown, including mask body 101, peripheral edge 102, peripheral section 104, mini voice amplifier 130, attachment point 138, valves 150, and filters 152, as described herein. Face mask 100 (and any other embodiment of a face mask as described herein) includes a first semi-pliable or metal customization strip 170 on the exterior surface of the mask in the nasal region and a second semi-pliable or metal customization strip 172 on the exterior surface of the mask in the chin region. Both the first semi-pliable or metal customization strip 170 and the second semi-pliable or metal customization strip 172 may be on the interior surface of the mask.

Referring to FIG. 5, face mask 100 is illustrated, including mask body 101, peripheral edge 102, peripheral section 104, mini voice amplifier 130, attachment point 138, valve 150, and filter 152, as described herein. Valve 150 may comprise a multiuse disposable exhalation/inhalation valve., Some face masks described herein can include one or more valves. In some preferred aspects the devices can include at least two valves, namely, at least one inhalation valve, and at least one exhalation valve. An exhalation valve can include at least one orifice that allows exhaled air to pass from an interior gas space to an exterior gas space during an exhalation. An inhalation valve has at least one orifice that allows inhaled air to pass from an exterior gas space to an interior gas space during an inhalation. The valve 150 is illustrated with respect to the positioning in mask body 101, for example, mask body 101 of FIGS. 1, 2, 4, and 5. The valves 150 of face mask 100 depicted in FIGS. 1, 2, 4, and 5 include TWO inhalation valves and two exhalation valves.

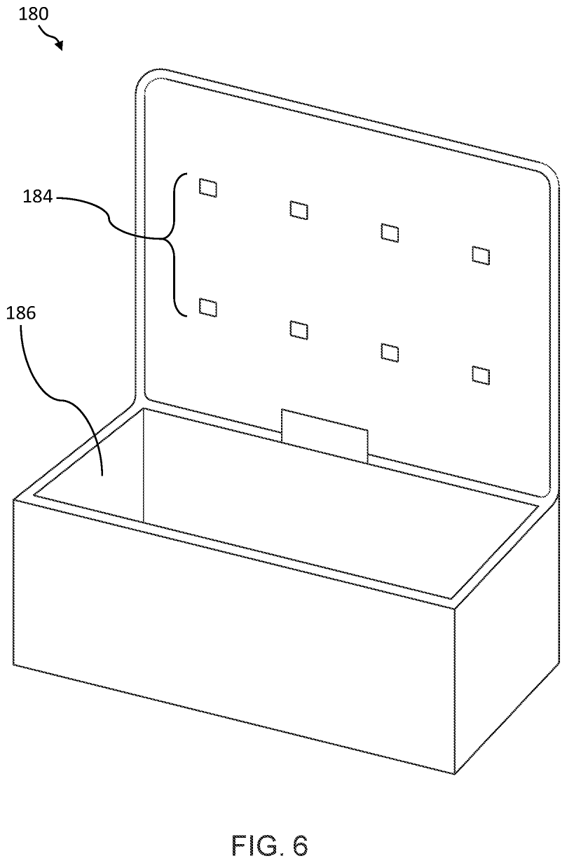

A sterilization storage box 180 is shown in FIG. 6. The lid 182 of the box 180 has LED UV lights 184. The interior of the box is coated with a reflective glass 186 so as to reflect the UV light in every direction to fully saturate the mask with its disinfecting and sterilizing power.

FIG. 7 depicts an example of the mini voice amplifier with speaker 130. This device is attached to the underside of the mask, but not limited to that location. The mini amplifier 130 has a power button 132 and a volume control 134 with the speaker portion 136 facing the outside of the mask and the backside of the speaker unit houses the microphone (not shown) which is sealed inside of the mask where it can capture the users speech.

Referring to FIG. 8, face mask 100 is shown, including mask body 101, peripheral edge 102, human face 120, mini voice amplifier 130, attachment point 138, attachment point 138, valves 150, filters 152, and head strap 160, as described herein. At attachment point 138, the user can, if so desired, attach additional devices, for example, a Bluetooth microphone for large speaking engagements, online conferences or situations that require more speaking volume than is normally required using the mini voice amplifier. Attachment point 138 is for additional devices including but not limited to breathing devices or oxygen lines, if so desired. Attachment point 138, under the user's chin, can be used for additional comfort if so desired and as an additional point for moisture removal. It should be noted that although the figures herein show specific attachment point locations, one or more attachment points in any location can be selected according the comfort and/or needs of the user.

As described above, FIG. 9 illustrates a passive-active adjustable strap system 262. The depicted system in FIG. 9 includes an elastomeric coupler 264 comprising an adjustable Velcro strap. This embodiment has an elastic strap that allows for comfort and customization. In addition, it is locked into position with the hook-and-loop fastener strip 266 comprising a Velcro hook and loop strap so as to make removing and replacing the mask on the face convenient and easy.

A valve 150 or 250 can include a filter element 152 or 252 that removes particulate matter from the air flow through the filter element. The filter element 152 or 252 can include any material suitable material, such as for example, a fibrous material or an open cell foam. In some embodiments, the filter element can qualify as a N95 filter, namely, a N95 rating of National Institute for Occupational Safety and Health (NIOSH). In some embodiments, the filter element can qualify as a N99 filter, namely, a N99 rating of NIOSH. In some embodiments, the filter element can qualify as a N100 filter, namely, a N100 rating of NIOSH. Any other suitable filter element can be included, for example, one with an OV-100 rating. In some embodiments, a valve, a filter element, or any component of the valve can be replaceable.

Valve 150 or 250 can include two chambers, air flow is permitted through the valve by the open outer housing with cross structures. In another embodiment, the valve housing can incorporate a detachable cover.

The valves filters 152 or 252 can be designed to be replaceable at scheduled intervals to be determined individually depending upon areas of use, for example, areas of use within a healthcare facility. In certain embodiments, a valve can include an indicator for the length of time the face mask has been used by a user. In such embodiments, the indicator can include, for example, crystals sensitive to repeated exposure to gases such as CO₂.

In another embodiment, a valve 150 or 250 can include a circumference, where the circumference is threaded. The threaded circumference of the valve 150 or 250 can be received by a threaded edge of the peripheral edge of an opening. A screwing action can seat a valve 150 or 250 into the threaded edge.

In another embodiment, a valve 150 or 250 snap fits with mild pressure directly into a recess in the peripheral edge of an opening. In some aspects, the inner perimeter of recess is sectioned out in locations around the perimeter.

In another embodiment, the valve 150 or 250 can incorporate a snap fit or threaded twist-on cover over the amplifier chamber such that the opening can be independent sealed if so desired.

In another embodiment, some of the face masks described herein can comprise a valve, where the valve includes a cover. In one embodiment, a valve can include a cover on the exterior surface of the valve. The cover can be molded such that an air flow can be restricted and forced to pass through another of the three openings in the mask.

It will be understood that any combination of valves described herein can be used with the face masks described herein. Also, with the instant disclosure, one of skill in the art can select other types of valves for use with the masks.

Another embodiment can incorporate fixation points in the upper outer portions of the mask body to which a disposable face shield, many examples of which exist, can be attached.

In some embodiments, the depicted face mask system includes a mask body, which includes two valves within the body and an insert that includes two openings, which are optional. Inserts are described more fully elsewhere herein. The respective openings and valves line up once the insert is inserted into the mask body (i.e., the openings are aligned with the valves). It should be noted that in some embodiments the insert can include “0” rings around the openings. The “0” rings can be configured to permit the insert to press fit over the valve housings in the mask body. The insert may be an N95+ filter (other filter elements can be used as well, e.g., N99, P100, OV-100, etc.).

The fitted mask can have retention members attached to it. The retention members can be any suitable members, including those as described herein. To remove the mask, the user does not have to detach the custom fitted hook and loop straps, but can instead simply stretch the attached strap3 slightly, via the elastomeric couplers, and thereby comfortably remove and replace the mask without having to reset the straps each time. As noted herein, the retention or restraining system can include a color coding system as well.

Before using the face mask, the one or more valves comprising filter elements can be secured into the mask body. Each filter can be the same, and their intended function can depend on how the filter is oriented into the mask body.

Some embodiments of the face masks described herein are reusable. Typically, masks of this type are of a one-time use disposable design. The costs to hospitals of the typical disposable surgical masks is not insignificant. Even more importantly the rise of Covid 19 has created a new class of isolation mask. Most users are reluctant to bear the cost associated with the one time use recommendation by health professionals because of the associated cost. As a direct and proximate result the single use mask is reused to the detriment of the user. The single use mask is also cheaply made and are not sufficient for the task they are purported to do. The single use mask was never designed for prolonged use and as a result are uncomfortable to wear and need constant repositioning and removal, which is contrary to their purpose. The single use mask is only designed for one specific use and thus are not flexible for the myriad of situations commonly confronting todays's users. The single use mask and reusable mask are often contaminated with the very contaminants that they purport to protect the user from and once stored these contaminants multiply and put the user at even greater risk. The embodiments in this invention remedy all of these concerns.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or components. Likewise, any two components so associated can also be viewed as being “operably connected”, or “operably coupled”, to each other to achieve the desired functionality, and any two components capable of being so associated can also be viewed as being “operably coupled”, to each other to achieve the desired functionality. Specific examples of operably coupled include but are not limited to physically malleable and/or physically interacting components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases one or more or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art in view of the instant disclosure. The various aspects and embodiments disclosed herein are for purposes of illustration and are not intended to be limiting, with the true scope and spirit being indicated by the following claims.

Although embodiments of the invention discussed and disclosed in the context of certain referred embodiments and examples, it will be understood by those skilled in the art that the present embodiments extend beyond the specifically disclosed embodiments to other alternative embodiments and/or uses of the embodiments and obvious modifications and equivalents thereof. In addition, while several variations of the embodiments have been shown and described in detail, other modifications, which are within the scope of these embodiments, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed embodiments. Thus, it is intended that the scope of at least some of the present technology and embodiments herein disclosed should not be limited by the particular disclosed embodiments described above.

### EXAMPLE

The BIO-Smart Mask™ is a four-layer mask made from surgical grade material. Our outer layer of spunbond polypropylene fabric is fluid-resistant and coated with BIO Smart Shield™, giving it its antiviral and antibacterial properties. The middle layers are made from non-woven melt-blown polypropylene fabric and act as filtering layers against pathogens. The inner layer of spunbond polypropylene fabric is a final barrier to prevent moisture penetrating the mask and effectively prevent fogging.

1. A multiuse reusable customizable ergonomic self-sanitizing communication friendly face mask comprising:
a) a generally clear plastic cup shaped mask body comprising an interior surface that is made of bio resistant material, an opening having a peripheral edge shaped to generally follow a contour of a human face extending around the nasal and oral areas, a recess shaped to receive oral and nasal features of a human face, and an exterior surface opposite the interior surface;
b) a first semi-pliable or metal customization strip on the interior or exterior surface of the mask in the nasal region;
c) a second semi-pliable or metal customization strip on the interior or exterior surface of the mask in the chin region;
d) a form fitting plastic member coupled to the peripheral edge, wherein the plastic member extends around at least a portion of the peripheral edge and onto the exterior and interior surfaces of the mask body, respectively;
e) at least two exhalation/inhalation valves disposed on the sides of the mask body allowing a clear view of the mouth, said valves to be positioned on the sides of the clear plastic mask so as not to obstruct the view of the mouth wherein said at least two valves each comprise a reusable, replaceable, multifunction filter element;
f) at least one valve opening to encompass a rechargeable Bluetooth voice amplifier device with built in speaker and microphone; and
g) at least one retention member attached to said mask body that is an adjustable reusable hook and loop Velcro fastener elastic strap.

2. (canceled)

3. The face mask of claim 1, wherein said face mask is constructed of clear soft plastic copolymer; wherein the mask body comprises one or more receptacles; wherein the at least two exhalation/inhalation valves are configured to fit into the one or more receptacles in the mask body; a customizable plastic member coupled to the peripheral edge of the mask, wherein the plastic member extends around the entire peripheral edge of the mask and onto the exterior and interior surfaces of the mask body; and wherein the hook and loop Velcro fastener elastic strap is configured to enable the mask to be adjusted using the hook and loop and then removed and replaced by stretching the elastic strap while removing without having to adjust the Velcro strap each time.

4. The face mask of claim 1, wherein said filter element comprises a N95 based filter insert, a N99 based filter insert, a P100 based filter insert, an OV-100 based filter insert, a dust filter insert, or an odor blocking insert.

5. The face mask of claim 1, further comprising a generally cup shaped insert comprising an opening and a recess, the recess shaped to receive oral and nasal features of a human face, and wherein said insert is customizable and form fitting.

6. The face mask of claim 1, wherein the first semi-pliable or metal customization strip is disposed at a location alignable with the nasal bridge of a user, and wherein the second semi-pliable or metal customization strip is disposed at a location alignable with the lower chin of a user.

7. (canceled)

8. The face mask of claim 1, wherein the hook and loop Velcro fastener elastic strap is configured to enable the mask to be adjusted using the hook and loop and then removed and replaced by stretching the elastic strap while removing without having to adjust the Velcro strap each time.

9. (canceled)

10. The face mask of claim 1, wherein the rechargeable Bluetooth voice amplifier is attached to the mask in such a way as to promote normal communication when the mask is worn without the need to remove the mask.

11. The face mask of claim 10, wherein the rechargeable Bluetooth voice amplifier with built in speaker and microphone is configured to fit into a receptacle in the mask body and wherein the amplifier is flush mounted to the mask.

12. The face mask of claim 10, wherein the Bluetooth voice amplifier is configured to amplify a user's voice and deliver clear and soft sound to cover normal speaking distances, thereby facilitating normal conversations in person or over the phone.

13. The face mask of claim 10, wherein the Bluetooth voice amplifier not only projects but amplifies a normal voice, and wherein the Bluetooth voice amplifier is configured to transmit the voice directly to other sources.

14. The face mask of claim 10, wherein the Bluetooth voice amplifier is rechargeable and comprises a built-in rechargeable lithium battery.

15. A multiuse reusable customizable ergonomic self-sanitizing communication friendly face mask system comprising the face mask of claim 1 and a sterilization box for housing and recharging the mask when not in use, wherein said sterilization box comprises an LED UV Sterilizer Box with Disinfecting Ultraviolet Bacteria Light and Sanitizer Cleaning Tool.

16. The system of claim 15, wherein the sterilization box is also configured to house and/or recharge multiple brands of mask, other devices, and/or personal items.

17. The system of claim 15, wherein the sterilization box is configured to provide wide wavelength coverage at 260-280 nm and comprises reflective glass to provide 360° of protection for universal support.

18. The system of claim 15, wherein the sterilization box is configured to be portable, easy to use, work quickly, and shut off automatically.

19. A method of reducing the spread of germs, bacteria, and impurities comprising using the system of claim 15 to sterilize the mask.

20. The face mask of claim 4, wherein the cup shaped insert is made from bio resistant clear plastic.
